(19) United States
(12) Patent Application Publication
(10) Pub. No.: US 2018/0248611 A1
(43) Pub. Date: Aug. 30, 2018

(54) ROUTE GENERATING DEVICE AND MULTI-HOP WIRELESS MESH NETWORK SYSTEM

(71) Applicant: Kabushiki Kaisha Toshiba, Minato-ku (JP)

(72) Inventors: Takeshi SAKODA, Shinagawa (JP); Yusuke DOI, Kawasaki (JP)

(73) Assignee: Kabushiki Kaisha Toshiba, Minato-ku (JP)

(21) Appl. No.: 15/677,150

(22) Filed: Aug. 15, 2017

(30) Foreign Application Priority Data
Feb. 24, 2017 (JP) 2017-033773

(51) Int. Cl. H04B 7/14; H04W 40/02; H04L 12/26

(52) U.S. Cl. CPC H04B 7/14; H04W 84/18; H04L 43/0811; H04W 40/02

(57) ABSTRACT

According to one embodiment, a route generating device exists in a multi-hop wireless mesh network including a transmission terminal, a destination group including a destination terminal, and a first relay group including a plurality of first wireless communication terminals. The route generating device includes a circuitry and a memory. The circuitry sets one of the plurality of first wireless communication terminals included in the first relay group as a first relay terminal, based on a connectivity in respect to the destination group. Furthermore, the circuitry generates a first route information for the first relay terminal to transfer data to the destination terminal when the first relay terminal receives the data, and transmits the first route information to the first relay terminal. The memory stores the first route information.

### CROSS-REFERENCE TO RELATED APPLICATION

This application is based upon and claims the benefit of priority from Japanese Patent Application No. 2017-033773, filed on Feb. 24, 2017; the entire contents of which are incorporated herein by reference.

### FIELD

Embodiments described herein relate generally to a route generating device and a multi-hop wireless mesh network system.

### BACKGROUND

In recent years, a building energy management system (BEMS) has been actively introduced in response to the demand for energy saving. The BEMS aims for energy saving by collecting data on the usage of infrastructure equipment (such as air conditioning equipment and lighting in a building) or the like, and by controlling the infrastructure equipment using the obtained data. This data collection and feedback of the control are performed mainly via a wired network at present. However, this is expected to be achieved by a wireless network since with the wired network, installation costs are high and installation sites are limited for replacement of the existing system. Depending on the space of the site where the equipment is installed, there are cases where all the wireless communication terminals cannot be directly connected to aggregation equipment which collects data in the wireless network. Therefore, it is necessary to use a multi-hop wireless mesh network capable of delivering data transmitted from one wireless communication terminal to the aggregation equipment via another wireless communication terminal that exists on the way to the aggregation equipment.

Ad hoc on-demand distance vector (AODV) or the like is known for the multi-hop wireless mesh network. The AODV is a method of setting route information through the exchange of management packets to check the route information prior to communication. The route information is information about which wireless communication terminal is routed through to communicate with a router or another wireless communication terminal. Such a method of exchanging management packets causes an enormous number of management packets to occupy the wireless bands since the multi-hop wireless mesh network includes an enormous number of wireless communication terminals. This may result in delay in data communication or unstable data communication.

### BRIEF DESCRIPTION OF THE DRAWINGS

FIG. 1 is an exemplary configuration of a multi-hop wireless mesh network system according to a first embodiment.

FIG. 2 is an exemplary configuration of a route generating device according to the first embodiment.

FIG. 3 is a flowchart illustrating an example of processing of the route generating device according to the first embodiment.

FIG. 4 is an example of structure of communication quality data that a communication-state collecting part 210 collects.

FIG. 5 is another exemplary configuration of the multi-hop wireless mesh network system according to a first modification of the first embodiment.

FIG. 6 is a flowchart illustrating another example of the processing of the route generating device according to the first embodiment.

FIG. 7 is a flowchart illustrating an example of processing of a route generating device according to the first modification of the first embodiment.

FIG. 8 is an example of route information according to the first modification of the first embodiment.

FIG. 9 is a flowchart illustrating an example of processing of a route generating device according to a second modification of the first embodiment.

FIG. 10 is a flowchart illustrating another example of the processing of the route generating device according to the second modification of the first embodiment.

FIG. 11 is a flowchart illustrating another example of the processing of the route generating device according to the second modification of the first embodiment.

FIG. 12 is a flowchart illustrating an example of processing of a route generating device according to a third modification of the first embodiment.

FIG. 13 is a flowchart illustrating another example of the processing of the route generating device according to the third modification of the first embodiment.

FIG. 14 is a flowchart illustrating another example of the processing of the route generating device according to the third modification of the first embodiment.

FIG. 15 is an example of route information according to the third modification of the first embodiment.

FIG. 16 is an exemplary configuration of a route generating device according to a second embodiment.

FIG. 17 is a flowchart illustrating an example of processing of the route generating device according to the second embodiment.

FIG. 18 is a block diagram illustrating an example of a hardware configuration according to a third embodiment.

### DETAILED DESCRIPTION

According to one embodiment, a route generating device exists in a multi-hop wireless mesh network including a transmission terminal, a destination group including a destination terminal, and a first relay group including a plurality of first wireless communication terminals. The route generating device includes a circuitry and a memory. The circuitry sets one of the plurality of first wireless communication terminals included in the first relay group as a first relay terminal, based on a connectivity in respect to the destination group. Furthermore, the circuitry generates a first route information for the first relay terminal to transfer data to the destination terminal when the first relay terminal receives the data, and transmits the first route information to the first relay terminal. The memory stores the first route information.

Embodiments will be described below. Detailed descriptions of common configurations and processing among the embodiments and modifications will be appropriately omitted.

### First Embodiment

A wireless communication terminal included in a multi-hop wireless mesh network system is, for example, controlled in operation by signals received from another wireless communication terminal included in the same multi-hop wireless mesh network system, or aggregates stored data in another wireless communication terminal. The plurality of wireless communication terminals included in the multi-hop wireless mesh network system exists at high density, for example.

In a case where a transmission terminal and a destination terminal included in the multi-hop wireless mesh network system cannot directly perform data communication or cannot perform data communication in a stable manner, a route generating device sets a relay terminal that relays the data communication between the transmission terminal and the destination terminal, and generates route information for the relay terminal.

The route generating device transmits the generated route information to the wireless communication terminal which serves as the relay terminal. The data from the transmission terminal is transmitted to the destination terminal via the relay terminal on the basis of the route information generated by the route generating device. The route generating device preliminarily stores identifiers of the plurality of wireless communication terminals included in the multi-hop wireless mesh network system and identifiers of groups to which the respective wireless communication terminals belong.

One or more relay terminals are provided. The following describes a case where one relay terminal (first relay terminal) is provided between a transmission terminal and a destination terminal.

Each wireless communication terminal included in the multi-hop wireless mesh network system is grouped on the basis of geographical information (position information), for example. It is assumed that a plurality of wireless communication terminals belonging to the same group can directly communicate with each other.

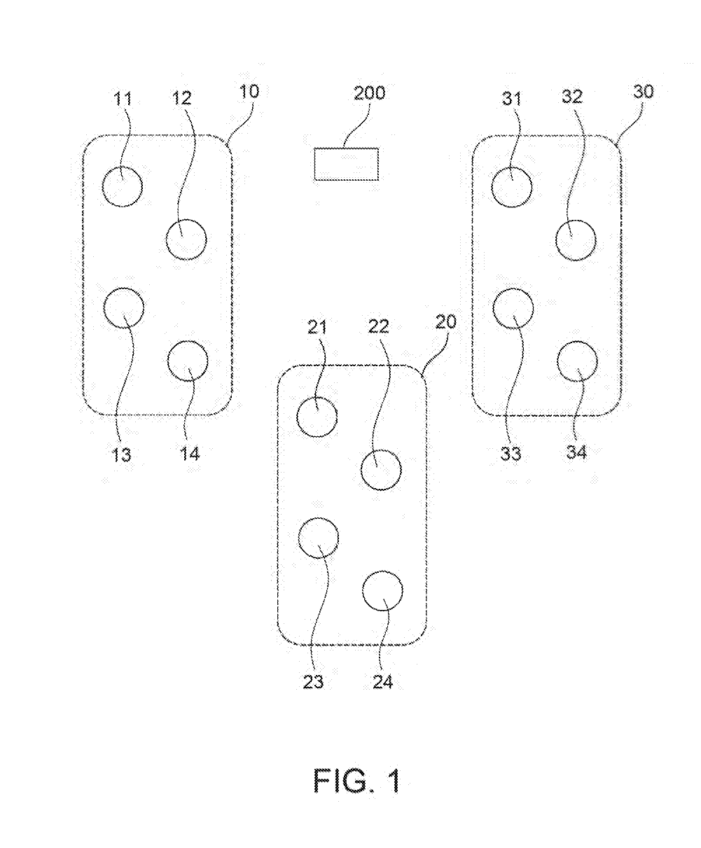

FIG. 1 is an exemplary configuration of the multi-hop wireless mesh network system according to the first embodiment. The multi-hop wireless mesh network system includes a plurality of wireless communication terminals (11 to 14, 21 to 24, 31 to 34) and a route generating device 200.

According to FIG. 1, a destination terminal (first wireless communication terminal) 11 and the wireless communication terminals 12 to 14 belong to a destination group (first group) 10. The wireless communication terminals 21 to 24 belong to a first relay group (second group) 20. A transmission terminal (third wireless communication terminal) 31 and the wireless communication terminals 32 to 34 belong to a transmission group (third group) 30. The first relay group 20 includes two or more wireless communication terminals. The destination group 10 and the transmission group 30 each include at least one wireless communication terminal.

The multi-hop wireless mesh network system may further include a wireless communication terminal that is not included in any of the destination group 10, the first relay group 20, and the transmission group 30. The multi-hop wireless mesh network system may include another group.

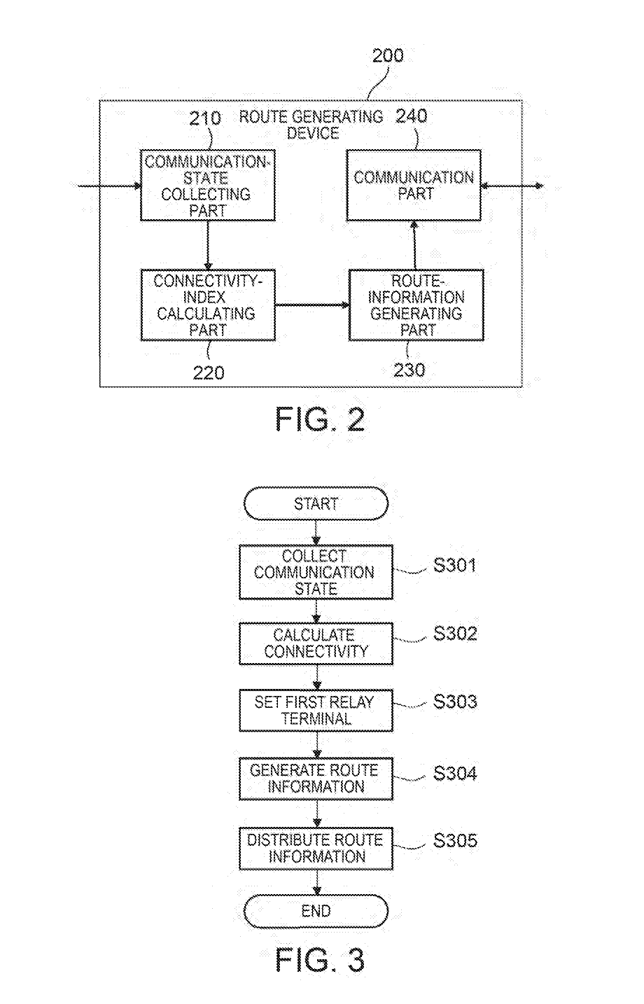

FIG. 2 is an exemplary configuration of the route generating device 200 according to the first embodiment. The route generating device 200 includes a communication-state collecting part 210, a connectivity-index calculating part 220, a route-information generating part 230, and a communication part 240.

FIG. 3 is a flowchart illustrating processing of the route generating device according to the first embodiment. The communication-state collecting part 210 collects communication quality data measured during mutual communication among the wireless communication terminals in the multi-hop wireless mesh network system (S301). As long as whether the value is large or small can be identified, anything may be used as communication quality data. For example, the greater the value is, the higher the communication quality data is. For example, one of a received signal strength indicator (RSSI), a decibel value or a true value of received power, and a signal noise rate (SNR) or a combination of two or more of these values may be used. A packet to be exchanged for the measurement just needs to include an identifier of the terminal of its own (which transmits the packet) and an identifier of a group to which the terminal of its own belongs in a payload. For example, a header of a media access control (MAC) frame, which is in a data link layer, used in a wireless standard conforming to IEEE 802.11 may be broadcasted together with the payload.

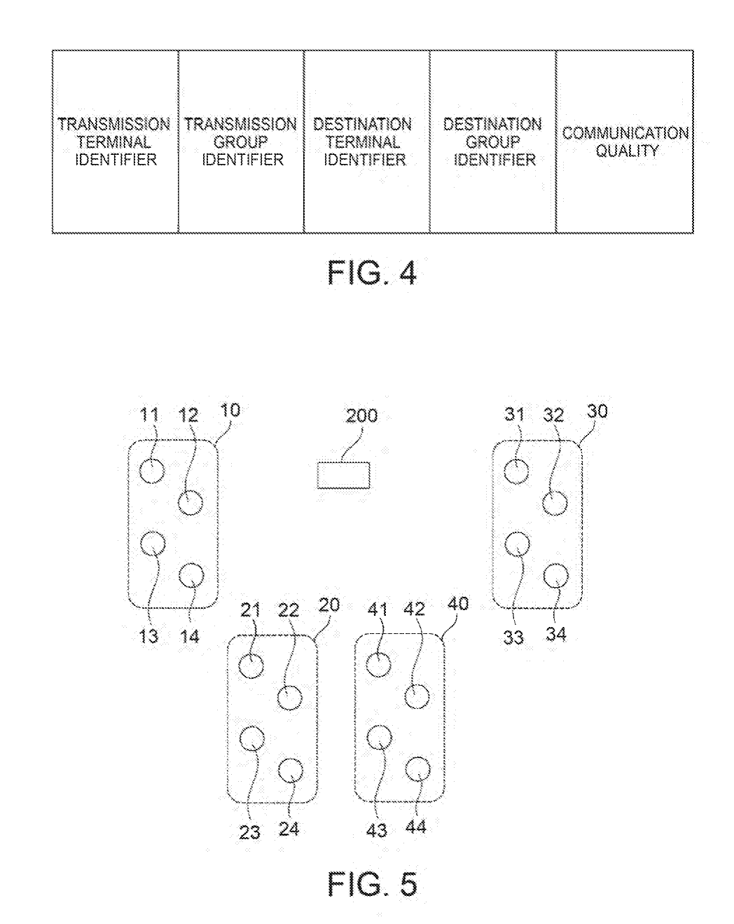

FIG. 4 is an example of the structure of the communication quality data according to the first embodiment. The communication quality data includes an identifier of the terminal transmitting the communication data, a transmission group identifier, a destination terminal identifier, a destination group identifier, and a value of communication quality for the communication data, for example. The communication quality data mutually communicated between each wireless communication terminal may be collected by the communication-state collecting part 210 in the data format illustrated in FIG. 4. As a collection method, the route generating device and each wireless communication terminal may directly transmit and receive the communication quality data, or may transmit and receive the communication quality data via an external storage device such as a secure digital (SD) card. When the collected data gathers, the communication-state collecting part 210 calls the connectivity-index calculating part 220.

The connectivity-index calculating part 220 calculates the connectivity of each of the wireless communication terminals belonging to the first relay group 20 in respect to the destination group 10 on the basis of the communication quality data between the wireless communication terminals collected by the communication-state collecting part (S302).

The connectivity-index calculating part 220 sorts the communication quality data by group using, for example, the identifiers of the wireless communication terminals that are transmission sources of the respective communication quality data collected by the communication-state collecting part 210. Subsequently, the connectivity-index calculating part 220 calculates the connectivity of each of the wireless communication terminals included in the first relay group 20 in respect to the destination group. The connectivity refers to an expected value that the data transmitted by one wireless communication terminal reaches one or more wireless communication terminals belonging to a group different from a group to which the wireless communication terminal transmitting the data belongs. A greater value implies a higher likelihood that the transmitted data is reached. The connectivity is calculated using either of a value of the communication quality or the number of links with the wireless communication terminal belonging to this different group, or a combination thereof. An example of an equation for the calculation of the connectivity is indicated below.

CE(connectivity)=(the number of links)×(Σ value of communication quality) (1)

According to the equation (1), the wireless communication terminal has higher connectivity, as the number of links with this different group is greater and the communication quality data with each wireless communication terminal belonging to this different group is greater. In a case where there is no wireless communication terminal that can communicate in this different group, the number of links=0, whereby the connectivity becomes 0, for example. The connectivity is calculated for each wireless communication terminal.

The route-information generating part 230 sets one of the wireless communication terminals belonging to the first relay group as a first relay terminal (second wireless communication terminal) on the basis of the connectivity calculated by the connectivity-index calculating part 220, and generates route information accordingly (S303, S304). For example, the wireless communication terminal having the highest connectivity in respect to the destination group is set as the first relay terminal among the wireless communication terminals belonging to the first relay group.

The route information is information for the first relay terminal to transfer to the destination terminal, data (destined for the destination terminal) transmitted from the transmission terminal when the first relay terminal receives the data. The first relay terminal directly or indirectly receives data from the transmission terminal. The first relay terminal may directly transmit the data to the destination terminal, or transmit the data to the destination terminal via another relay terminal. The route information associated with the first relay terminal includes, for example, an identifier of the destination group 10 and an identifier of the transmission terminal 31.

The communication part 240 receives the route information stored in the route-information generating part 230 and distributes the route information to the first relay terminal (S305). The communication part 240 may distribute the route information to a plurality of wireless communication terminals including the first relay terminal. Each wireless communication terminal receives and stores the route information on the terminal of its own. As a distribution method, the route generating device and each wireless communication terminal may directly transmit and receive the route information, or may transmit and receive the route information via an external storage device such as an SD card.

When the transmission terminal 31 transmits data destined for the destination terminal 11 and a first relay terminal 21 receives this data, the first relay terminal 21 transfers the data to the destination terminal 11. Even when the wireless communication terminals (22 to 24) other than the first relay terminal 21 included in the first relay group 20 receive the data from the transmission terminal 31, the wireless communication terminals (22 to 24) do not transfer the data to the destination terminal 11. Even when the wireless communication terminals that are included in the transmission group 30 and other than the first relay terminal receive the data from the transmission terminal 31, the wireless communication terminals do not transfer the data to the destination terminal 11.

FIG. 5 is another exemplary configuration of the multi-hop wireless mesh network system according to the first embodiment.

There are some cases where the multi-hop wireless mesh network system includes a plurality of groups other than the destination group 10 and the transmission group 30, and the first relay terminal 21 and the transmission group 30 cannot perform data communication. In such cases, the transmission terminal 31 and the first relay terminal 21 performs data communication via one or a plurality of relay terminals selected from the wireless communication terminals that do not belong to the destination group 10 and the first relay group 20 on the basis of the connectivity in respect to the first relay group 20.

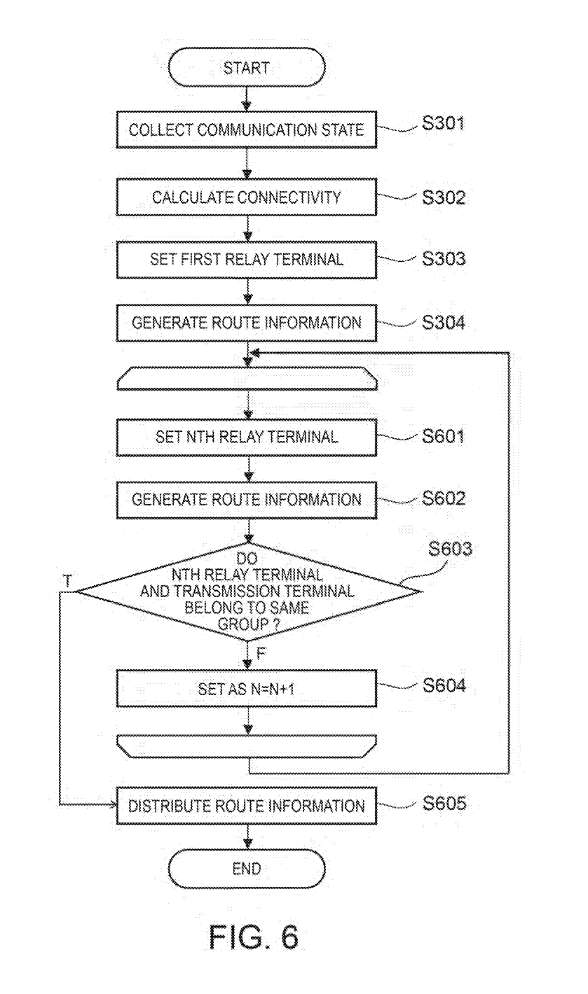

FIG. 6 is a flowchart illustrating another example of the processing of the route generating device according to the first embodiment. The processing in S301 to S304 is the same as the processing in FIG. 3. After the first relay terminal is set, an Nth relay terminal is set on the basis of the connectivity in respect to the first relay group (S601). The Nth relay terminal belongs to an Nth group. N is a positive integer equal to or greater than 2 and is a value one greater than the number of relay terminals that have already been set. In the example of FIG. 5, N is 2 since the first relay terminal has already been set. A second relay terminal 41 belongs to a second relay group 40.

Subsequently, route information with the Nth relay terminal set as the relay terminal is generated (S602). The route information is information for the second relay terminal to transfer to the first relay terminal, data (destined for the destination terminal) transmitted from the transmission terminal when the second relay terminal receives the data. The second relay terminal directly or indirectly receives data from the transmission terminal. Specifically, the route information includes, for example, the identifier of the destination group 10 and the identifier of the transmission terminal 31 in the route information associated with the Nth relay terminal.

If the Nth relay terminal and the transmission terminal do not belong to the same group (F in S603), the value of N is updated to N +1 (S604). Subsequently, the Nth relay terminal is set on the basis of the connectivity in respect to the (N−1)th relay group. For example, if the second relay terminal 41 does not belong to the same group as the transmission terminal 31, N is set to 3 and a third relay terminal is set on the basis of the connectivity in respect to the second relay group. Until the Nth relay terminal belonging to the same group as the transmission terminal is found, the setting of the relay terminal and the generation of the route information are repeated.

If the Nth relay terminal and the transmission terminal belong to the same group (T in S603), the Nth relay terminal and the transmission terminal can directly communicate with each other. Therefore, the generation of the route information is ended and the route information is distributed (S605).

In this manner, the route is sequentially set from the destination group, not from the transmission group. In a case where a plurality of relay terminals is included in one route, each relay terminal belongs to a group different from one another.

According to the present embodiment, it is possible to generate route information which is appropriate for the combination of the destination terminal and the transmission terminal. Since the route information is generated before data communication in the present embodiment, management packets do not need to be exchanged, thereby allowing efficient use of wireless bands. As a result, data communication can be performed without delay between the wireless communication terminals. Furthermore, since a packet loss rate during data communication can be reduced, the data communication can be performed in a stable manner between the wireless communication terminals.

The position information of each group may be included in the grouping information set in advance. In a case where the route-information generating part 230 sets a relay terminal and an angle between a position vector of the transmission group with respect to the destination group and a position vector of the relay group with respect to the destination group is large, it is possible to avoid setting a detour route by setting a biasing such that any wireless communication terminal included in this relay group is less likely to be selected as the relay terminal.

### First Modification of First Embodiment

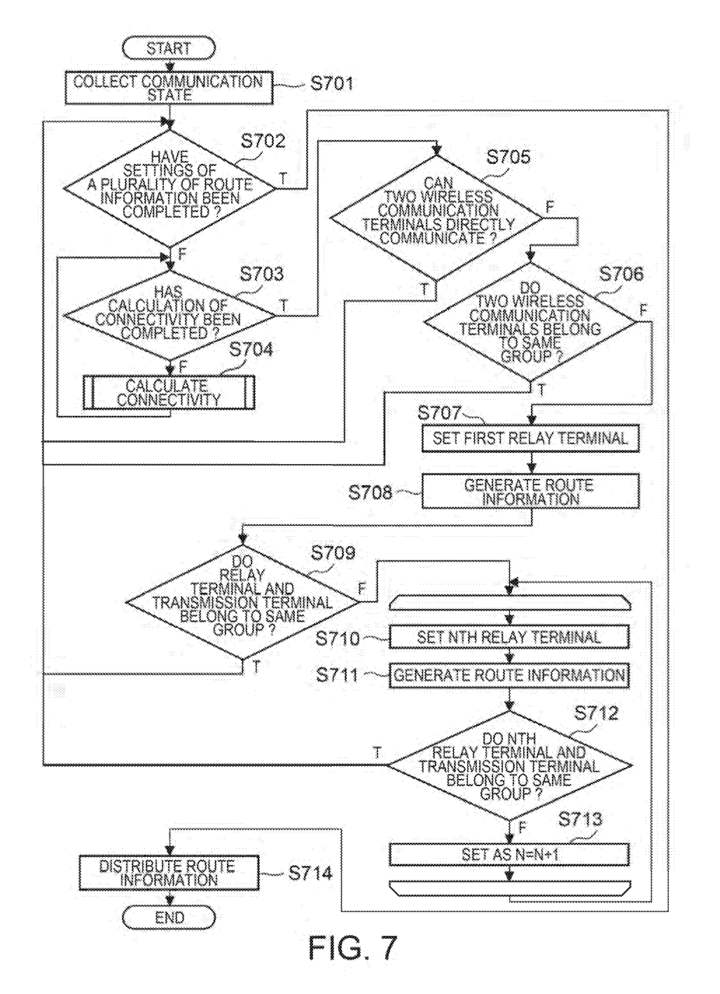

The following describes a case of generating a plurality of pieces of route information corresponding to a plurality of combinations of destination terminals 11 and transmission terminals 31. The route information may be obtained for all of the combinations including two of the wireless communication terminals included in the multi-hop wireless mesh network system. FIG. 7 is a flowchart illustrating an example of processing of the route generating device according to the first modification of the first embodiment.

The communication-state collecting part 210 collects communication quality with which the wireless communication terminals in the multi-hop wireless mesh network system have mutually communicated (S701). Subsequently, if the settings of the pieces of route information for the plurality of combinations of the destination terminals 11 and the transmission terminals 31 have been completed (T in S702), the pieces of route information are distributed from the route generating device 200 to the wireless communication terminals (S714). If the settings of the pieces of route information for the plurality of combinations have not been completed (F in S702), it is determined whether the connectivity of the plurality of wireless communication terminals included in the multi-hop wireless mesh network system in respect to each of the plurality of groups included in the multi-hop wireless mesh network system has been calculated (S703). The connectivity may be calculated for all of the wireless communication terminals included in the multi-hop wireless mesh network system.

If the calculation of the connectivity has not been completed (F in S703), the connectivity which has not been calculated is calculated (S704). If the calculation of the connectivity has been completed (T in S703), the necessity of setting route information is determined for the combination of the destination terminal 11 and the transmission terminal 31 for which the route information has not been set yet. Specifically, if the destination terminal 11 and the transmission terminal 31 relating to one of the pieces of route information that have not been set yet can directly communicate with each other, the route information is not created (T in S705) and processing returns to S702.

If the destination terminal 11 and the transmission terminal 31 relating to one of the pieces of route information that have not been set yet cannot directly communicate with each other (F in S705), it is determined whether the destination terminal 11 and the transmission terminal 31 belong to the same group (S706). If the two terminals belong to the same group (T in S706), processing returns to S702 without creating the route information since the wireless communication terminals within a group can mutually communicate with each other.

If the two terminals do not belong to the same group (F in S706), the route information is created. One of the wireless communication terminals which do not belong to the destination group is set as a first relay terminal on the basis of the connectivity in respect to the destination group (S707). The route information is generated by adding an identifier of the destination group and an identifier of the transmission terminal to the route information associated with the first relay terminal (S708). For example, an entry in which the identifier of the destination group and the identifier of the transmission terminal are described is added to the route information. After that, it is determined whether the first relay group to which the first relay terminal belongs is the same as the transmission group. If both are the same, the route information generating processing for the two wireless communication terminals is ended (T in S709), and processing returns to S702.

On the other hand, if the first relay group 20 and the transmission group 30 are not the same (F in S709), an Nth relay terminal for transferring data to an (N−1)th relay terminal is set (S710). The Nth relay terminal is set on the basis of the connectivity in respect to the (N−1) th relay group. N is an integer equal to or greater than 2 and is a value one greater than the number of relay terminals that has already been set for the route. Until this point, the first relay terminal has already been set. Therefore, N is 2. For example, the second relay terminal is a wireless communication terminal having the highest connectivity in respect to the first relay group.

The route information is generated by adding an entry to the route information associated with the Nth relay terminal (S711). In the entry, the identifier of the destination group and the identifier of the transmission terminal are described. After that, it is determined whether the Nth relay group to which the Nth relay terminal belongs is the same as the transmission group (S712). If both are the same, the route information generating processing is ended (T in S712), and processing returns to S702. If the Nth relay group and the transmission group are different (F in S712), the value of N is incremented by one (S713), a new Nth relay terminal is set (S710), and route information is generated (S711). This processing is repeated until the relay terminal belonging to the transmission group is set. For example, after the second relay terminal is set, N is set to 3 and a third relay terminal is set. If the third relay group to which the third relay terminal belongs is different from the transmission group, a fourth relay terminal is set.

By completing the series of processing, the settings of the pieces of route information for all of the plurality of combinations of the destination terminals 11 and the transmission terminals 31 are completed. For example, it is also possible to generate the pieces of route information for combinations of all of the destination terminals and transmission terminals included in the multi-hop wireless mesh network system.

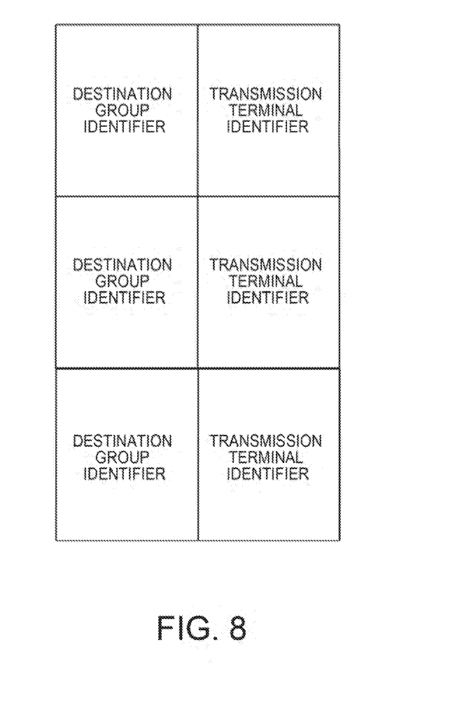

FIG. 8 is an example of the route information according to the first modification of the first embodiment. In a case where a plurality of routes is set in the multi-hop wireless mesh network system, one wireless communication terminal may operate as a relay terminal for two or more routes. In this case, the route information associated with this wireless communication terminal includes a plurality of combinations of identifiers of destination groups and identifiers of transmission terminals. In FIG. 8, one destination group identifier and one transmission terminal identifier arranged side by side represent one combination. When the wireless communication terminal receives data to be transmitted to a destination group included in one combination from a transmission terminal in the same combination, the wireless communication terminal functions as a relay terminal and transmits the data to the next relay terminal.

According to the present modification, it is possible to generate route information which is appropriate for the plurality of combinations of destination terminals and transmission terminals. Since the route information is generated before data communication in the present modification, management packets do not need to be exchanged, thereby allowing efficient use of wireless bands. As a result, data communication can be performed without delay between the wireless communication terminals. Furthermore, since a packet loss rate during data communication can be reduced, the data communication can be performed in a stable manner between the wireless communication terminals.

### Second Modification of First Embodiment

In the first embodiment, there may be a case where the destination terminal and the first relay terminal cannot directly communicate with each other. A method that can be applied for this case is to generate route information such that any one of the wireless communication terminals in the destination group retransmits data from the first relay terminal. This is because the terminals within the destination group can communicate with each other.

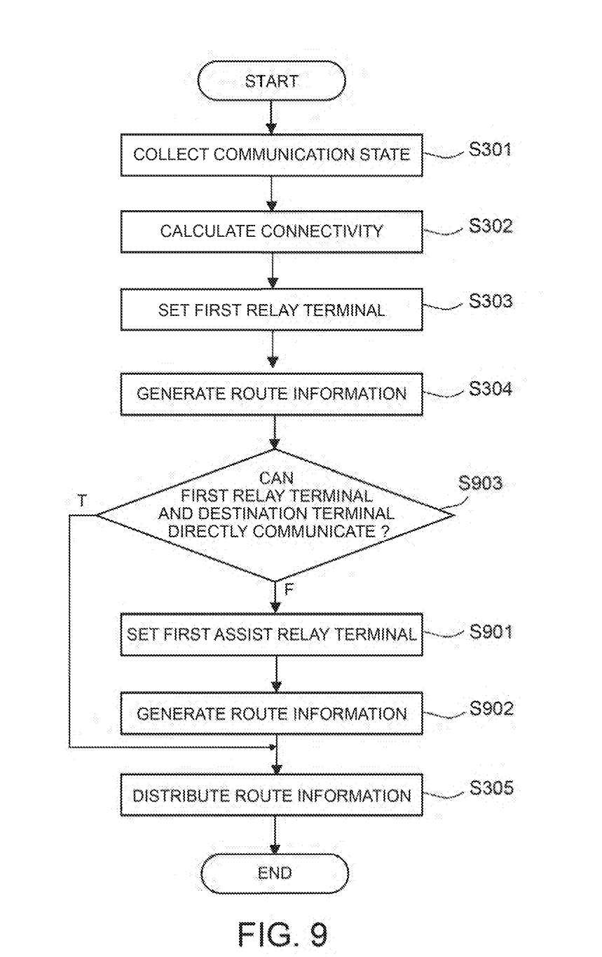

FIG. 9 is a flowchart illustrating an example of processing of the route generating device according to the second modification of the first embodiment. FIG. 9 is an example in which S901 to S903 are added to FIG. 3. The processing until the determination of the first relay terminal (S301 to S303) is the same as the processing in FIGS. 3 and 6. After the first relay terminal is set and the route information is generated (S304), it is determined whether the first relay terminal and the destination terminal can directly communicate with each other on the basis of communication quality data (S903). If direct communication is possible (T in S903), the processing in S305 is performed in the same manner as in FIG. 3. If direct communication is not possible (F in S903), one wireless communication terminal that is included in the destination group and can directly communicate with the first relay terminal is set as a first assist relay terminal (S901). Subsequently, route information associated with the first assist relay terminal is generated (S902).

The route information is information for the first assist relay terminal to transfer to the destination terminal, data (destined for the destination terminal) transmitted from the transmission terminal when the first assist relay terminal receives the data. The route information associated with the first assist relay terminal includes the identifier of the destination group and the identifier of the transmission terminal. After that, the route information is distributed (S305).

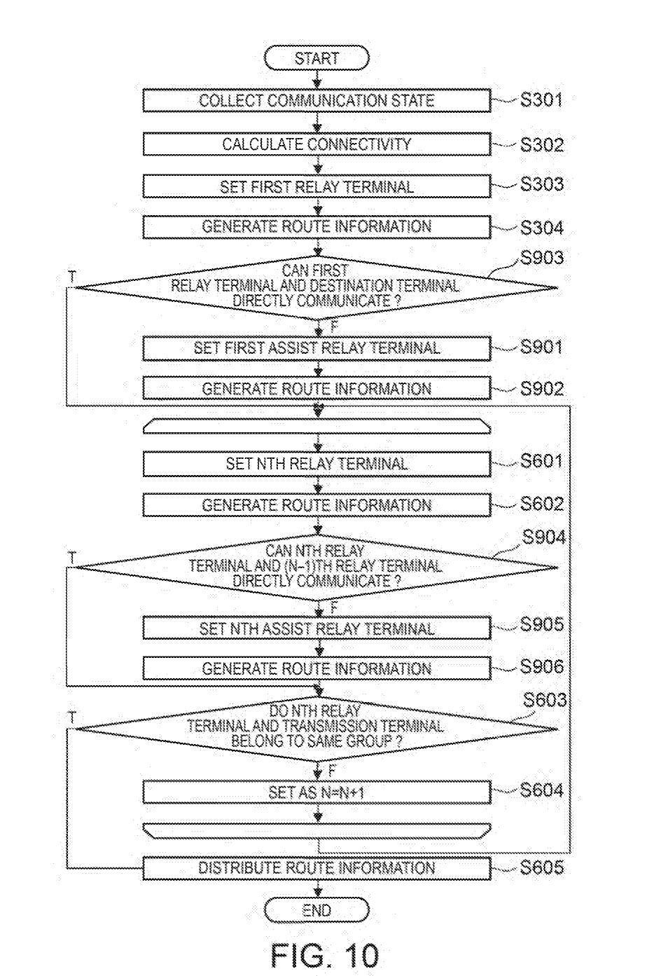

FIG. 10 is a flowchart illustrating another example of the processing of the route generating device according to the second modification of the first embodiment. FIG. 10 is an example in which S901 to S906 are added to FIG. 6.

After the route information associated with the first relay terminal (S304) is generated, if the first relay terminal and the destination terminal can directly communicate with each other (T in S903), an Nth relay terminal is set (S601). If direct communication is not possible between the first relay terminal and the destination terminal (F in S903), one wireless communication terminal that is included in the destination group and can directly communicate with the first relay terminal is set as a first assist relay terminal (S901). Subsequently, route information associated with the first assist relay terminal is generated (S902). The route information associated with the first assist relay terminal includes the identifier of the destination group and the identifier of the transmission terminal. Subsequently, the Nth relay terminal is set (S601). After the route information of the Nth relay terminal is generated (S602), it is determined whether the Nth relay terminal and the (N−1)th relay terminal can directly communicate with each other (S904). If direct communication is possible, it is determined whether the Nth relay terminal and the transmission group belong to the same group (S603).

If direct communication is not possible, one wireless communication terminal that is included in the (N−1)th relay group and can directly communicate with the Nth relay terminal is set as an Nth assist relay terminal (S905). Subsequently, route information associated with the Nth assist relay terminal is generated (S906). The route information associated with the Nth assist relay terminal includes the identifier of the destination group and the identifier of the transmission terminal. Subsequently, if direct communication is possible, it is determined whether the Nth relay terminal and the transmission group belong to the same group (S603). The description after S603 is omitted since it is the same as in FIG. 6. Until the relay terminal belonging to the transmission group is set, the relay terminal and the assist relay terminal are set one after another and the route information is generated one after another.

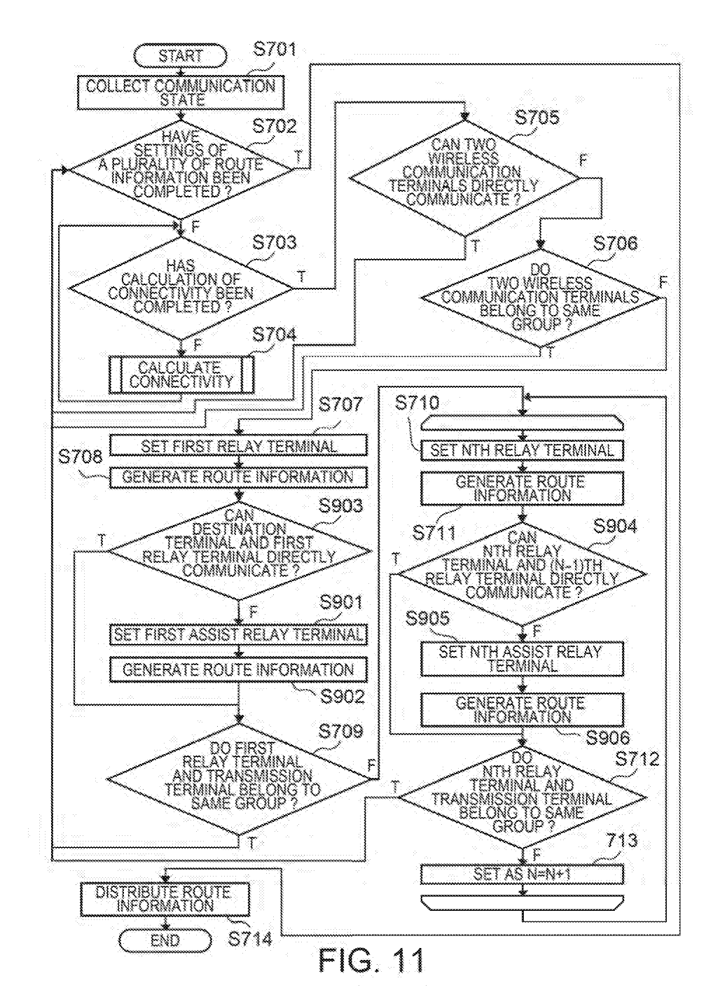

Next, the following describes a case where a plurality of routes is set in the multi-hop wireless mesh network system. FIG. 11 is a flowchart illustrating another example of the processing of the route generating device according to the second modification of the first embodiment. FIG. 11 is an example in which S901 to S906 are added to FIG. 7.

After the route information associated with the first relay terminal is generated (S708), if the first relay terminal and the destination terminal can directly communicate with each other (T in S903), an Nth relay device is set (S701). If direct communication is not possible between the first relay terminal and the destination terminal (F in S903), one wireless communication terminal that is included in the destination group and can directly communicate with the first relay terminal is set as a first assist relay terminal (S901). Subsequently, route information associated with the first assist relay terminal is generated (S902). The route information associated with the first assist relay terminal includes the identifier of the destination group and the identifier of the transmission terminal. Subsequently, the Nth relay terminal is set (S710). After the route information of the Nth relay terminal is generated (S711), it is determined whether the Nth relay terminal and the (N−1)th relay terminal can directly communicate with each other (S904). If direct communication is possible, it is determined whether the Nth relay terminal and the transmission group belong to the same group (S712).

If direct communication is not possible, one wireless communication terminal that is included in the (N−1)th relay group and can directly communicate with the Nth relay terminal is set as an Nth assist relay terminal (S905). Subsequently, route information associated with the Nth assist relay terminal is generated (S906). The route information associated with the Nth assist relay terminal includes the identifier of the destination group and the identifier of the transmission terminal. Subsequently, if direct communication is possible, it is determined whether the Nth relay terminal and the transmission group belong to the same group (S712). The description after S713 is omitted since it is the same as in FIG. 7. Until the relay terminal belonging to the transmission group is set, the relay terminal and the assist relay terminal are set one after another and the route information is generated one after another.

According to the present modification, in a case where the first relay terminal and the destination terminal cannot directly perform data communication, the data communication can be performed via the first assist relay terminal. Furthermore, in a case where the Nth relay terminal and the (N−1)th relay terminal cannot directly perform data communication, the data communication can be performed via an Nth assist relay terminal. Therefore, this allows a situation to be avoided in which the route needs to be abandoned when direct connection cannot be established with the destination terminal even with high connectivity. Furthermore, this allows the creation of a route that enables stable delivery of data from the transmission terminal to the destination terminal.

Since the route information is generated before data communication in the present modification, management packets do not need to be exchanged, thereby allowing efficient use of wireless bands. As a result, data communication can be performed without delay between the wireless communication terminals. Furthermore, since a packet loss rate during data communication can be reduced, the data communication can be performed in a stable manner between the wireless communication terminals.

### Third Modification of First Embodiment

The third modification of the first embodiment will be described with reference to the drawings.

The present modification reduces communication cut-off when one wireless communication terminal in a route becomes inoperative due to a failure or the like.

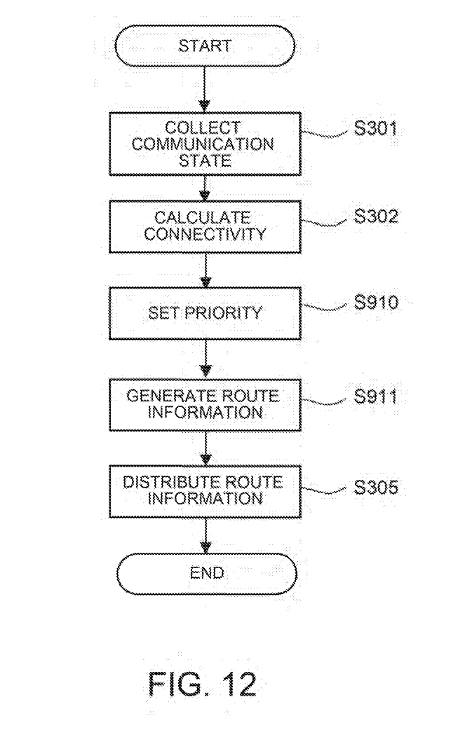

FIG. 12 is a flowchart illustrating an example of the processing of the route generating device according to the third modification of the first embodiment. In FIG. 12, S303 in FIG. 3 is changed to S910, and 5304 is changed to S911. In the present modification, after the connectivity is calculated (S302), a plurality of first relay terminals are set in the first relay group. Specifically, wireless communication terminals whose values of the connectivity in respect to the destination group are not 0 are stored in a retransmission candidate list (it is also called as “a relay candidate list”). That is, the wireless communication terminals stored in the retransmission candidate list can perform data communication with at least one wireless communication terminal included in the destination group. For example, the relay candidate list is generated by the connectivity-index calculating part. Subsequently, among the wireless communication terminals included in the relay candidate list, wireless communication terminals having higher connectivity in respect to the destination group are given a higher priority (S910). Then, the pieces of route information associated with all the wireless communication terminals given the priority or each of the plurality of wireless communication terminals given the higher priority are generated (S911).

The priority is defined as an integer of 0 or greater, for example. The smaller the value is, the higher the priority is. When the plurality of first relay terminals included in the first relay group receives data from a wireless communication terminal included in another group, the wireless communication terminal whose priority is set higher transmits the received data to the destination group earlier than the others. For example, the plurality of first relay terminals may be given a wait time between reception and transmission according to the priority.

The route information is information for the wireless communication terminal (stored in the retransmission candidate list) to transfer to the destination terminal, data (destined for the destination terminal) transmitted from the transmission terminal after the wait time corresponding to the priority when the wireless communication terminal receives the data, for example. The route information includes, for example, the identifier of the destination group, the identifier of the transmission terminal, and the priority.

In a case where all the wireless communication terminals whose connectivity is not 0 are included in the relay candidate list, the number of pieces of route information becomes enormous and the calculation load becomes large. Therefore, the number of wireless communication terminals to be stored in the retransmission candidate list may be limited.

In a case where the present modification is applied to the flowchart in FIG. 9, S303 is replaced with S910 and S304 is replaced with S911, similarly.

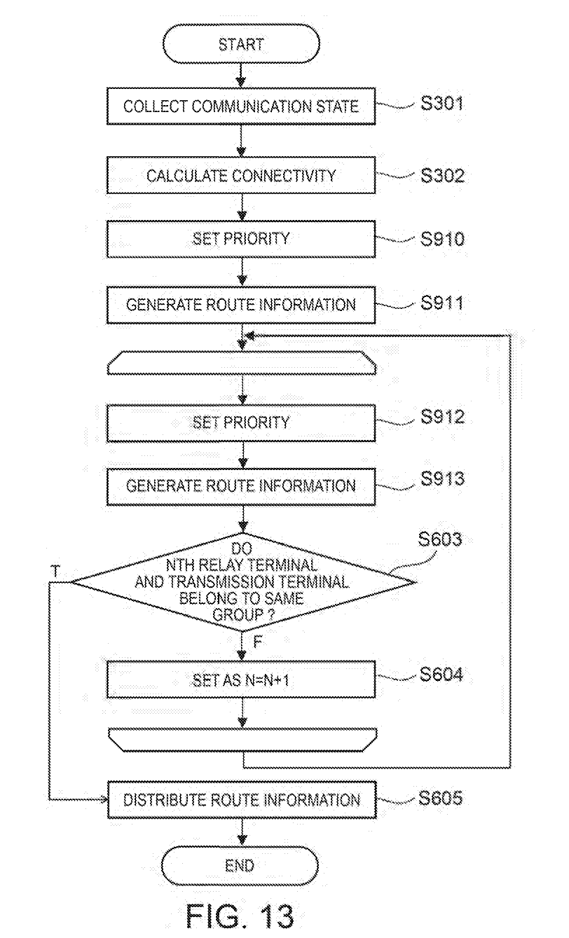

FIG. 13 is a flowchart illustrating another example of the processing of the route generating device according to the third modification of the first embodiment. In FIG. 13, S303 in FIG. 6 is changed to S910, S304 is changed to S911, S601 is changed to S912, and S602 is changed to S913. In S910, as in the case of FIG. 12, a plurality of first relay terminals is set in the first relay group on the basis of the connectivity, and the priority is set for each of the plurality of first relay terminals on the basis of the corresponding connectivity (S910). Subsequently, the pieces of route information associated with all the wireless communication terminals given the priority or each of the plurality of wireless communication terminals given the higher priority are generated (S911). When the plurality of first relay terminals included in the first relay group receives data from a wireless communication terminal included in another group, the wireless communication terminals whose priorities are set higher transmit the received data to the destination group earlier.

Similarly, a plurality of Nth relay terminals is set in the Nth relay group on the basis of the connectivity, and the priority is set for each of the plurality of Nth relay terminals on the basis of the corresponding connectivity (S912). Subsequently, the pieces of route information associated with all the wireless communication terminals given the priority or each of the plurality of wireless communication terminals given the higher priority are generated (S913). When the plurality of Nth relay terminals included in the Nth relay group receives data from a wireless communication terminal included in another group, the wireless communication terminals whose priorities are set higher transmit the received data to the (N−1)th group earlier.

In a case where the present modification is applied to the flowchart in FIG. 10, S303 is replaced with S910, S304 is replaced with S911, S701 is replaced with S912, and S702 is replaced with S913, similarly.

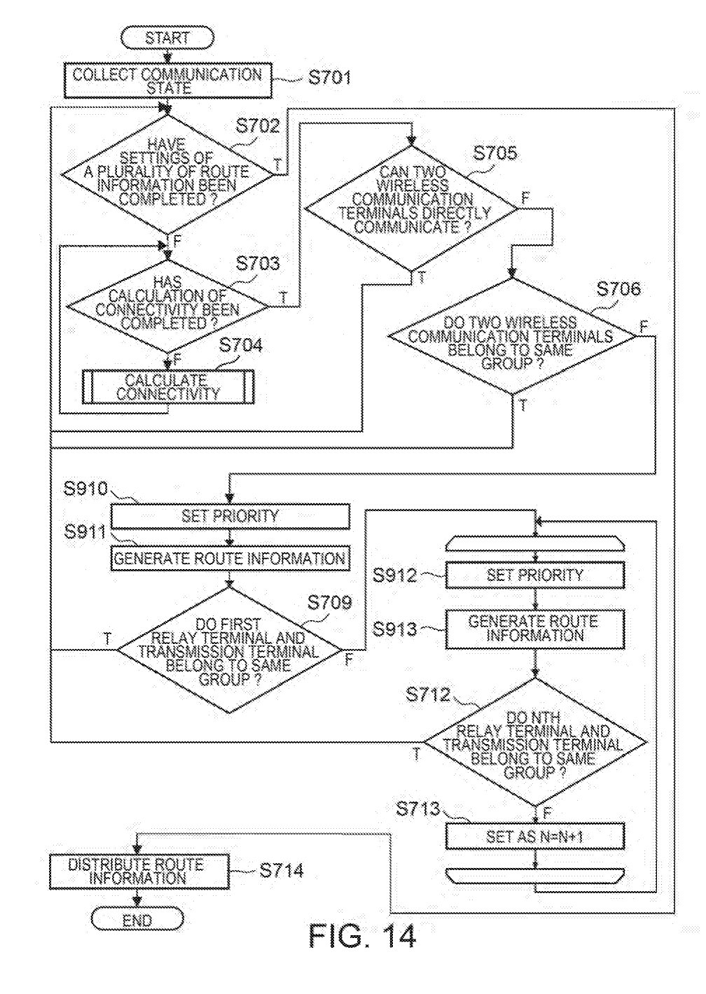

FIG. 14 is a flowchart illustrating another example of the processing of the route generating device according to the third modification of the first embodiment. In FIG. 14, S707 in FIG. 7 is changed to S910, S708 is changed to S911, S710 is changed to S912, and S711 is changed to S913.

The description of S910 to S913 is the same as in FIG. 13.

In a case where the present modification is applied to the flowchart in FIG. 11, S707 is replaced with S910, S708 is replaced with S911, S710 is replaced with S912, and S711 is replaced with S913, similarly.

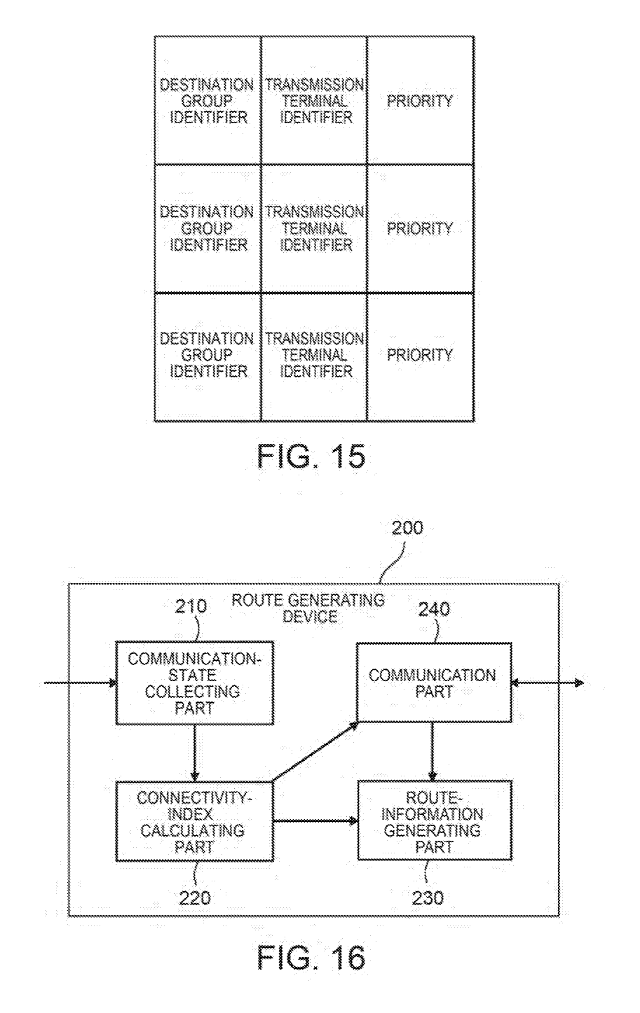

FIG. 15 is an example of the route information according to the third modification of the first embodiment. In the example of FIG. 14, in a case where a plurality of routes is set in the multi-hop wireless mesh network system, one wireless communication terminal may operate as a relay terminal for two or more routes. In this case, the route information associated with this wireless communication terminal includes a plurality of combinations of identifiers of destination groups, identifiers of transmission terminals, and priorities. In FIG. 15, one destination group identifier, one transmission terminal identifier, and the priority arranged side by side represent one combination. In FIG. 15, the route information includes three combinations. When the wireless communication terminal receives data to be transmitted to a destination group included in one combination from a transmission terminal included in the same combination, the wireless communication terminal functions as a relay terminal and transmits the data to the next relay terminal after the wait time corresponding to the priority.

According to the present modification, since the plurality of redundant routes are formed, communication can be performed in a stable manner even if some wireless communication terminals included in the multi-hop wireless mesh network system become inoperative due to a failure.

Since the route information is generated before data communication in the present modification, management packets do not need to be exchanged, thereby allowing efficient use of wireless bands. As a result, data communication can be performed without delay between the wireless communication terminals. Furthermore, since a packet loss rate during data communication can be reduced, the data communication can be performed in a stable manner between the wireless communication terminals.

### Second Embodiment

The following describes a case where a route generating device is incorporated as a module in a plurality of wireless communication terminals. FIG. 16 is an exemplary configuration of the route generating device according to the second embodiment. In the present embodiment, it is assumed that each wireless communication terminal grasps identifiers of all the other wireless communication terminals and groups to which the respective wireless communication terminals belong. That is, the multi-hop wireless mesh network includes at least a transmission group, a destination group including a destination terminal, and a relay group including a plurality of wireless communication terminals. Each of the plurality of wireless communication terminals includes the corresponding route generating device.

The plurality of wireless communication terminals mutually communicates with each other, and a communication-state collecting part 210 included in a route generating device 200 included in each wireless communication terminal collects communication quality data. Unlike the first embodiment, the communication-state collecting part 210 included in one wireless communication terminal collects communication quality data between this wireless communication terminal and another wireless communication terminal that can directly perform data communication therewith. A connectivity-index calculating part 220 calculates the connectivity of this wireless communication terminal in respect to another group on the basis of the collected communication quality data. The calculated connectivity is transmitted to a route-information generating part 230.

Subsequently, the connectivity-index calculating part 220 calls a communication part 240, and the communication part 240 transmits data to and receives data from another wireless communication terminal.

A route generation request is transmitted from one wireless communication terminal included in the multi-hop wireless mesh network system to another wireless communication terminal. There may be a plurality of other wireless communication terminals to which the route generation request is transmitted. The route generation request includes an identifier of a group to which a wireless communication terminal as a destination terminal belongs and an identifier of a wireless communication terminal as a transmission terminal. The wireless communication terminal that has received the route generation request exchanges the connectivity calculated by the connectivity-index calculating part 220 with the surrounding other wireless communication terminals via the communication part 240. The communication part 240 may also distribute the connectivity index calculated by the connectivity-index calculating part 220.

Subsequently, the connectivity of the other wireless communication terminals obtained by the communication part 240 is transmitted to the route-information generating part 230. The connectivity of the other wireless communication terminals received by the exchange is passed on to the route-information generating part 230, and it is determined whether this wireless communication terminal can be a first relay terminal.

This determination is made by comparing the connectivity of the terminal of its own with the connectivity of the surrounding other wireless communication terminals. In a case where the connectivity of the terminal of its own in respect to the destination group is higher than the connectivity of the other wireless communication terminals in respect to the destination group, the terminal of its own is determined to be the first relay terminal. An entry in which an identifier of the destination group and an identifier of the transmission terminal are described is added to the route information stored by the terminal of its own. Furthermore, as in the third modification of the first embodiment, the priority based on the connectivity may be included in the route information.

The wireless communication terminal determined to serve as the first relay terminal retransmits the route generation request received from the wireless communication terminal (as a request source terminal) to another wireless communication terminal. On the other hand, in a case where the connectivity of the terminal of its own in respect to the destination group is lower than the connectivity of the other wireless communication terminals in respect to the destination group, a flag indicating that the route generating processing has once been executed is set, and the route information generating processing is ended.

A plurality of pieces of route information can be generated by repeating the above processing until a new route generation request is not retransmitted.

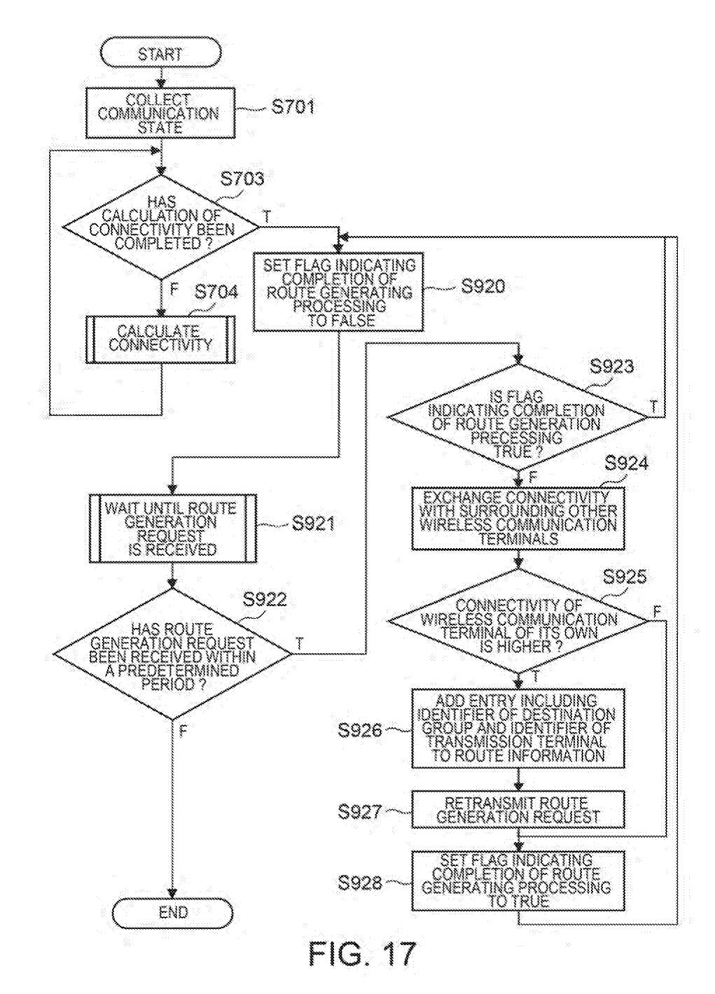

FIG. 17 is a flowchart illustrating an example of processing of the route generating device according to the second embodiment. First, the communication-state collecting part 210 collects communication quality data (S701). Subsequently, the connectivity-index calculating part 220 determines, for example, whether the connectivity between this wireless communication terminal and all the other groups has been calculated on the basis of the collected communication quality data. If all of the connectivity in respect to the other groups have not been calculated (F in S703), the connectivity-index calculating part 220 calculates the connectivity in respect to the other groups that has not been calculated yet (S704). If all of the connectivity in respect to the other groups have been calculated (T in S703), a flag indicating that the route-information generating part 230 has completed route generating processing is set to false (S920). Subsequently, the wireless communication terminal waits until a route generation request from another wireless communication terminal is received (S921). If the route generation request is not received from another wireless communication terminal within a certain period of time (F in S922), the route generating processing is ended.

On the other hand, if the route generation request is received from another wireless communication terminal within a certain period of time (T in S922), a flag indicating that the route generating processing has been completed is determined to be true or not. If the flag is true (T in S923), processing returns to S920.

If the flag indicating that the route generating processing has been completed is false (F in S923), the connectivity is exchanged with each other via the surrounding other wireless communication terminals (S924). Subsequently, if the connectivity between the terminal of its own and the destination group included in the route generation request is higher than the connectivity between the other wireless communication terminals and the destination group (T in S925), an entry including the identifier of the destination group and the identifier of the transmission terminal is added to the route information stored in the route-information generating part 230 (S926). After that, the route generation request is retransmitted to another wireless communication terminal (S927). After the flag indicating that the route generating processing has been completed is set to true, processing returns to S920. If the connectivity between the terminal of its own and the destination group included in the route generation request is lower than the connectivity between the other wireless communication terminals and the destination group (F in S925), processing in S928 is performed and processing returns to S920.

By executing above-mentioned processing by the plurality of wireless communication terminals, the routes can be generated.

Since the route information is generated before data communication in the present embodiment, management packets do not need to be exchanged, thereby allowing efficient use of wireless bands. As a result, data communication can be performed without delay between the wireless communication terminals. Furthermore, since a packet loss rate during data communication can be reduced, the data communication can be performed in a stable manner between the wireless communication terminals.

In the embodiments and modifications described above, the route information is generated using the connectivity as a metric. In the multi-hop wireless mesh network, however, it is also possible to generate the route information not only with the connectivity but also with the number of hops, which indicates the number of retransmissions, or with both of the connectivity and the number of hops. In a case where the number of hops is used, the number of communications between a third wireless communication terminal and a first wireless communication terminal is minimized.

Accordingly, it is possible to generate a route in which communication delay is minimum.

### Third Embodiment

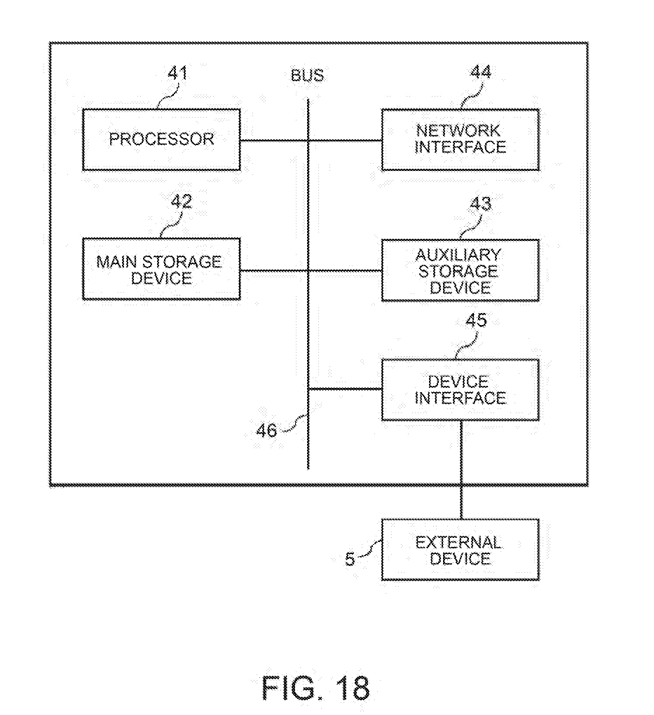

FIG. 18 is a block diagram illustrating an example of a hardware configuration according to one embodiment. The route generating device includes a processor 41, a main storage device 42, an auxiliary storage device 43, a network interface 44 and a device interface 45, and can be implemented as a computer device in which they are connected via a bus 46.

The processor 41 reads a program from the auxiliary storage device 43, deploys and executes the program in the main storage device 42 so that the functions of the communication-state collecting part 210, the connectivity-index calculating part 220, the route-information generating part 230, and the communication part 240 can be implemented as a circuitry.

The route generating device according to the present embodiment may be implemented by installing a program to be executed in the computer device in advance, by storing the program in a storage medium such as a compact disc read-only memory (CD-ROM), or by installing the program in the computer device via a network as appropriate.

The main storage device 42 is a memory device that temporarily stores instructions to be executed by the processor 41, various data and the like, and may be a volatile memory such as a dynamic random-access memory (DRAM) or a nonvolatile memory such as a magnetic random-access memory (MRAM). The auxiliary storage device 43 is a storage device that permanently stores a program, data and the like, and is a hard disk drive (HDD) or a solid-state drive (SSD), for example.

A network interface 44 is an interface for connecting to a communication network. Communication with a wireless device (not shown in FIG. 18) may be implemented by this network interface 44. Although just one network interface 44 is illustrated in Fig.18, a plurality of network interfaces may be mounted.

The device interface 45 is an interface to which a device such as an external device 5 is connected. An input part 11 and an output part 17 may be connected to the device interface 45 as external devices.

Hereinabove, the embodiments of the present invention have been described with reference to specific examples. However, the embodiments of the present invention are not limited to these specific examples.

Furthermore, any two or more components of the specific examples combined within the extent of technical feasibility may also be included in the scope of the present invention to the extent that the gist of the present invention is included.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A route generating device in a multi-hop wireless mesh network including a transmission terminal, a destination group including a destination terminal, and a first relay group including a plurality of first wireless communication terminals,
the route generating device comprising:
a circuitry configured to
set one of the plurality of first wireless communication terminals included in the first relay group as a first relay terminal, based on a connectivity in respect to the destination group,
generate a first route information for the first relay terminal to transfer data to the destination terminal when the first relay terminal receives the data, and
transmit the first route information to the first relay terminal; and
a memory configured to store the first route information.

2. The route generating device according to claim 1,
wherein, among the first wireless communication terminals, the circuitry sets one wireless communication terminal having the highest connectivity in respect to the destination group as the first relay terminal.

3. The route generating device according to claim 1,
wherein the multi-hop wireless mesh network further includes a second relay group including a plurality of second wireless communication terminals,
the circuitry
sets one of the plurality of second wireless communication terminals as a second relay terminal, based on a connectivity in respect to the first relay group,
generates a second route information for the second relay terminal to transfer to the first relay terminal, data transmitted from the transmission terminal and destined for the destination terminal when the second relay terminal receives the data, and
transmits the second route information to the second relay terminal.

4. The route generating device according to claim 1,
wherein the destination group includes, in addition to the destination terminal, a third relay terminal capable of directly communicating with the destination terminal and the first relay terminal,
the circuitry
generates a third route information for the third relay terminal to transfer to the destination terminal, data transmitted from the transmission terminal and destined for the destination terminal when the third relay terminal receives the data, and
transmits the third route information to the third relay terminal.

5. The route generating device according to claim 1,
wherein the circuitry
sets a priority to each of the plurality of first wireless communication terminals, based on the connectivity in respect to the destination group,
generates a fourth route information for the plurality of first wireless communication terminals to transfer to the destination terminal, data transmitted from the transmission terminal and destined for the destination terminal after a wait time corresponding the priority when the plurality of first wireless communication terminals receives the data, and
transmits the fourth route information to the plurality of first wireless communication terminals.

6. The route generating device according to claim 1, wherein the circuitry
obtains a communication quality between the destination terminal and the plurality of first wireless communication terminals, and
calculates the connectivity of the plurality of first wireless communication terminals in respect to the destination group, based on the communication quality.

7. A route generating device equipped in one wireless communication terminal among a plurality of wireless communication terminals included in a relay group,
a multi-hop wireless mesh network including a transmission terminal, a destination group including a destination terminal, and the relay group,
the route generating device comprising:
a circuitry configured to
obtain a first connectivity between the destination group and the wireless communication terminals except for the one wireless communication terminal; and
if a second connectivity between the destination group and the one wireless communication terminal is higher than the first connectivity, generate a first route information for the one wireless communication terminal to transfer to the destination terminal, data transmitted from the transmission terminal and destined for the destination terminal when the one wireless communication terminal receives the data; and
a memory configured to store the first route information.

8. A multi-hop wireless mesh network system comprising:
the route generating device according to claim 1;
the transmission terminal;
the destination group including the destination terminal; and
the first relay group including the plurality of first wireless communication terminals.

9. A multi-hop wireless mesh network system comprising:
the plurality of wireless communication terminals each equipping the route generating device according to claim 7;
the transmission terminal; and
the destination group including the destination terminal.
